(19) United States
(12) Patent Application Publication
(10) Pub. No.: US 2022/0126369 A1
(43) Pub. Date: Apr. 28, 2022

(54) SYSTEMS AND METHODS FOR SELECTIVE LASER SINTERING OF SILICON NITRIDE AND METAL COMPOSITES

(71) Applicant: SINTX Technologies, Inc., Salt Lake City, UT (US)

(72) Inventors: Bryan J. McEntire, Salt Lake City, UT (US); Bhajanjit Singh Bal, Salt Lake City, UT (US); Ryan M. Bock, Salt Lake City, UT (US)

(21) Appl. No.: 17/509,690

(22) Filed: Oct. 25, 2021

Related U.S. Application Data
(60) Provisional application No. 63/104,823, filed on Oct. 23, 2020.

(51) Int. Cl. B22F 10/28; B22F 12/41; B22F 10/66; B22F 10/62; B22F 12/58; B22F 1/00; B22F 10/68; B33Y 10/00; B33Y 40/10; B33Y 40/20; B33Y 70/00; B33Y 80/00

(52) U.S. Cl. CPC B22F 10/28; B22F 2302/20; B22F 10/66; B22F 10/62; B22F 12/58; B22F 1/0014; B22F 10/68; B33Y 10/00; B33Y 40/10; B33Y 40/20; B33Y 70/00; B33Y 80/00; B22F 2201/013; B22F 2201/016; B22F 2201/02; B22F 2301/205; B22F 12/41

(57) ABSTRACT

Methods and systems for manufacturing a component are disclosed. The method for manufacturing a component typically comprises blending a silicon nitride powder and a titanium alloy powder to form a combined powder; receiving the combined powder within a build chamber having a platform and a laser beam source configured to produce a laser beam; spreading a plurality of layers of the combined powder over the platform; fusing at least a portion of the combined powder in each of the plurality of layers using the laser beam, wherein each one of the plurality of layers is spread and the portion of the combined powder fused before another one of the plurality of layers is spread, wherein the laser beam is automatically guided by a 3D model of the component; and removing the combined powder that was not fused.

### CROSS-REFERENCE TO RELATED APPLICATIONS

This application claims priority to U.S. Provisional Application No. 63/104,823, filed Oct. 23, 2020, the contents of which are entirely incorporated by reference herein.

### FIELD

The present disclosure relates to systems and methods for manufacturing a component, and particularly to manufacturing a component using selective laser sintering or melting. Aspects of the disclosure relate to components or implants produced by the systems and methods disclosed herein.

### BACKGROUND

3D printing is an additive manufacturing (AM) technique for fabricating a wide range of structures and complex geometries from three-dimensional (3D) model data. The process typically consists of printing successive layers of materials that are formed on top of each other. 3D printing technology was developed by Charles Hull in 1986 in a process known as stereolithography (SLA), which was followed by subsequent developments such as powder bed fusion, fused deposition modelling (FDM), inkjet printing, and contour crafting (CC). 3D printing, which involves various methods, materials, and equipment, has evolved over the years and has the ability to transform manufacturing and logistics processes.

Improvements in 3D printing have led to growth in the field of rapid prototyping. Generally, rapid prototyping refers to the manufacture of articles directly from computer-aided-design (“CAD”) databases in an automated fashion, rather than by conventional machining of prototype articles according to engineering drawings. As a result, the time required to produce prototype parts from engineering designs has been reduced from several weeks to a matter of a few hours in some cases.

Selective laser sintering has enabled the direct manufacture of three-dimensional articles of high resolution and dimensional accuracy from a variety of materials including polystyrene, Nylon, other plastics, and composites such as polymer coated metals and ceramics. Additive manufacturing has enabled direct fabrication of molds from a CAD database representation of an object; in this case, computer operations “invert” the CAD database representation of the object, to directly form the negative from the powder.

There is an ongoing need for improved methods for manufacturing components.

### SUMMARY

The present disclosure relates to methods and systems for manufacturing a component, and particularly to manufacturing a component using selective laser sintering or melting. Aspects of the disclosure also relate to components or implants produced by the methods disclosed herein.

The methods for manufacturing a component disclosed herein advantageously enable the efficient and speedy production of components. In addition, the methods disclosed herein enable the production of customized components, such as biomedical implants. The methods of manufacture utilize a unique composition to produce components that simultaneously have high structural stability and improved bioactivity, which is highly desirable for implants. For example, the components may have enhanced osteoconductivity, osseous integration, and anti-pathogenicity. In some instances, the components may be configured to be implants having improved bioactivity, which is desirable for dental implants, spinal implants, joint components, and the like. Although the components may be configured to be customized medical implants, in some embodiments the components may be configured to be an object with a high contact surface, such as handles, knobs, levers, bed rails, chairs, moveable lamps, light switches, cellular phone cases, tray tables, small counter surfaces, or the like.

In accordance with a first aspect, a method for manufacturing a component typically comprises blending a silicon nitride powder and a metal powder to form a combined powder; receiving the combined powder within a build chamber having a platform and a laser beam source operable to produce a laser beam; spreading a plurality of layers of the combined powder over the platform; fusing at least a portion of the combined powder in each of the plurality of layers using the laser beam, wherein each one of the plurality of layers is spread and the portion of the combined powder fused before another one of the plurality of layers is spread and wherein the laser beam is automatically guided by a 3D model of the component; and removing the combined powder that was not fused by the laser beam.

The combined powder may contain about 1 to about 35 vol. % of silicon nitride powder and about 65 to about 99 vol. % of metal powder. In at least one embodiment, the combined powder contains about 10 to about 20 vol. % of silicon nitride powder and about 80 to about 90 vol. % of metal powder. In at least one other embodiment, the combined powder is about 15 vol. % of silicon nitride powder and about 85 vol. % of metal powder. In some examples, the combined powder may consist of or consist essentially of silicon nitride powder and titanium alloy powder. The titanium alloy powder may preferably be Ti6Al4V. The metal powder may have a powder size distribution of about 20 microns to about 300 microns. In some exemplary embodiments, the metal powder may have a powder size distribution of about 20 microns to about 65 microns. Additionally, or alternatively, the silicon nitride powder may have a powder size distribution of about 20 microns to about 300 microns. In some instances, the combined powder has a packing density of about 25 to about 60% of their theoretical values.

The method may include using a laser to fuse, via melting or sintering, the combined powder by heating the combined powder to a temperature of about 1000° C. to about 1700° C. Preferably, the laser fuses, via sintering, the combined powder by heating the combined powder to a temperature of about 1000° C. to about 1700° C.

The method may employ atmospheric pressure within the build chamber. In some cases, the build chamber contains (N₂) gas, e.g., during operation. In other cases, the build chamber contains ammonia (NH₃) gas, e.g., during operation. In further cases, the build chamber contains a combination of hydrogen (H₂) gas and nitrogen (N₂), e.g., during operation.

In at least one embodiment, the method may further include machining a surface of the component. In other embodiments, machining the surface of the component comprises polishing a surface of the component and/or performing chemical etching on a surface of the components.

According to a second aspect, provided is an implant comprising about 1 to about 35 vol. % of silicon nitride and about 65 to about 99 vol. % of a metal powder that is produced by a method, which includes blending a silicon nitride powder and a titanium alloy powder to form a combined powder; receiving the combined powder within a build chamber having a platform and a laser beam source operable to produce a laser beam; spreading a plurality of layers of the combined powder over the platform; fusing at least a portion of the combined powder in each of the plurality of layers using the laser beam, wherein each one of the plurality of layers is spread and the portion of the combined powder fused before another one of the plurality of layers is spread, wherein the laser beam is automatically guided by a 3D model of the component; and removing the combined powder that was not fused from the component.

The implant may comprise a titanium alloy powder that is Ti6Al4V. In some cases, the implant further comprises about 0.1 vol. % or more of iron, aluminum, copper, nickel, cobalt, chromium, alloys thereof, or combinations thereof. In at least one embodiment, the osteoblast cell proliferation increases on the implant as compared to an implant without the silicon nitride powder. Preferably, the implant may be antipathogenic. For instance, the implant may inhibit the proliferation of at least one of bacteria, fungi, and viruses.

### BRIEF DESCRIPTION OF THE DRAWINGS

The accompanying drawings, which are incorporated in and constitute a part of this specification, illustrate several embodiments of the invention and together with the description serve to explain the principles of the invention.

FIG. 1 is a flow chart representation of an exemplary, non-limiting embodiment of a method for manufacturing a component in accordance with an aspect of the present disclosure.

FIG. 2 is a model of a cervical implant to be manufactured according to an aspect of the present disclosure.

FIG. 3 is an image of a cervical implant manufactured according to an aspect of the present disclosure.

FIG. 4 is another image of the cervical implant of FIG. 3.

FIG. 5 is a model of a lumbar implant to be manufactured according to an aspect of the present disclosure.

FIG. 6 is an image of a lumbar implant manufactured according to an aspect of the present disclosure.

FIG. 7 is an image of a lumbar implant manufactured according to the present disclosure.

It should be understood that the various aspects are not limited to the arrangements shown in the drawings.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Thus, references to one or an embodiment in the present disclosure can be references to the same embodiment or any embodiment; and such references mean at least one of the embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

As used herein, the terms “comprising,” “having,” and “including” are used in their open, non-limiting sense. The terms “a,” “an,” and “the” are understood to encompass the plural as well as the singular. Thus, the term “a mixture thereof” also relates to “mixtures thereof.”

As used herein, the term “silicon nitride” includes α-Si₃N₄, β-Si₃N₄, SiYAlON, SiYON, SiAlON, or combinations thereof.

Generally, the ranges provided are meant to include every specific range within, and combination of sub ranges between, the given ranges. Thus, a range from 1-5, includes specifically 1, 2, 3, 4 and 5, as well as sub ranges such as 2-5, 3-5, 2-3, 2-4, 1-4, etc. All ranges and values disclosed herein are inclusive and combinable. For examples, any value or point described herein that falls within a range described herein can serve as a minimum or maximum value to derive a sub-range, etc. Other than in the operating examples, or where otherwise indicated, all numbers expressing quantities of ingredients and/or reaction conditions may be modified in all instances by the term “about,” meaning within +/−5% of the indicated number.

The term “substantially free” or “essentially free,” as used herein, means that there is less than about 2% by weight or by volume of a specific material/component added to a composition, based on the total weight of the compositions. All of the materials/components set forth herein may be optionally included or excluded from the method and/or the components disclosed herein.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure relates to systems and methods for manufacturing a component, and particularly to manufacturing a component using selective laser sintering or melting.

The methods for manufacturing a component disclosed herein advantageously enable the production of customized components. For example, the methods disclosed herein enable the production of customized components, such as biomedical implants. Additionally, the methods of manufacture utilize a unique composition to produce components (e.g., implants) that simultaneously have high structural stability and improved bioactivity. For example, the components may have enhanced osteoconductivity, osseous integration, and anti-pathogenicity. In some instances, the components may be advantageously configured to be implants having improved bioactivity, which is highly desired for dental implants, spinal implants, joint components, and the like.

Alternatively, in some embodiments, the components may be manufactured as customized components that preferably provide improved bioactivity to components/objects having a high contact surface, such as handles, knobs, levers, bed rails, chairs, moveable lamps, light switches, cellular phone cases, tray tables, small counter surfaces, or the like. One of ordinary skill in the art would recognize other benefits to employing aspects of the instant invention in various industries.

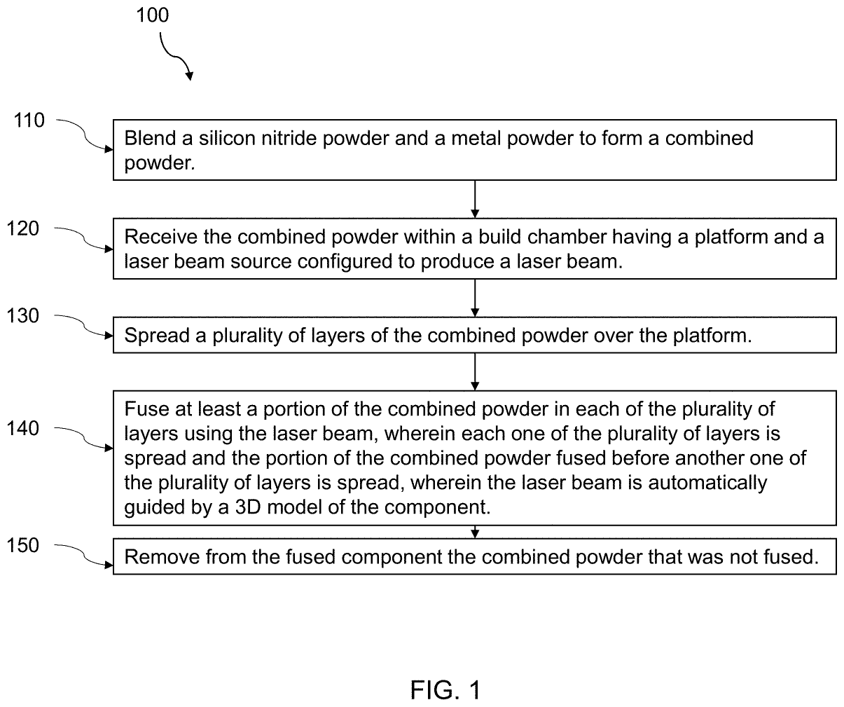

FIG. 1 is a flow chart of an exemplary, non-limiting method 100 for manufacturing a component. As a brief overview, method 100 includes blending a silicon nitride powder and a metal powder to form a combined powder in step 110; receiving the combined powder within a build chamber having a platform and a laser beam source operable to produce a laser beam in step 120; spreading a plurality of layers of the combined powder over the platform in step 130; fusing at least a portion of the combined powder in each of the plurality of layers using the laser beam in step 140, and removing the combined powder that was not fused by the laser beam in step 150.

In step 110, a silicon nitride powder and a metal powder are blended to form a combined powder. In some examples, the metal may include, but is not limited to titanium alloys, steel, nickel based superalloys, austenitic nickel-chromium-based superalloys, copper, aluminum, stainless steel, tool steels, cobalt-chromium alloys, tungsten alloys, silicon, and silicon alloys. In some embodiments, the metal powder is a titanium alloy powder. The titanium alloy powder may have a composition of Ti6Al4V.

The combined powder may contain about 5 to about 25 vol. % of silicon nitride powder and about 75 to about 95 vol. % of metal powder. For instance, the amount of silicon nitride powder present in the combined powder may be about 5 to about 25 vol. %, about 10 to about 25 vol. %, about 15 to about 25 vol. %, about 20 to about 25 vol. %; about 5 to about 20 vol. %, about 10 to about 20 vol. %, about 15 to about 20 vol. %; about 5 to about 15 vol. %, about 10 to about 15 vol. %; or about 5 to about 10 vol. %, based on the total volume of the combined powder. The amount of metal powder present in the combined powered may be about 75 to about 95 vol. %, about 80 to about 95 vol. %, about 85 to about 95 vol. %, about 90 to about 95 vol. %; about 75 to about 90 vol. %, about 80 to about 90 vol. %, about 85 to about 90 vol. %; about 75 to about 85 vol. %, about 80 to about 85 vol. %; or about 75 to about 80 vol. %, based on the total volume of the combined powder. In at least one embodiment, the combined powder contains about 10 to about 20 vol. % of silicon nitride powder and about 80 to about 90 vol. % of metal powder. In at least one other embodiment, the combined powder is about 15 vol. % of silicon nitride powder and about 85 vol. % of metal powder.

The method may employ a combined powder that includes about 20 vol. % or less of an additional powder, based on the total volume of the combined powder. In some instances, the amount of additional powder present in the combined powder is about 18 vol. % or less, about 16 vol. % or less, about 14 vol. % or less, about 12 vol. % or less, about 10 vol. % or less, about 8 vol. % or less, about 6 vol. % or less, about 4 vol. % or less, about 2 vol. % or less, or about 1 vol. % or less. In at least one instance, the combined powder consists of or consists essentially of silicon nitride powder, titanium alloy powder, and impurities. The additional powder may comprise iron, aluminum, copper, nickel, cobalt, chromium, alloys thereof, or combinations thereof.

The metal powder may have a powder size distribution of about 20 microns to about 300 microns. Additionally, or alternatively, the silicon nitride powder may have a powder size distribution of about 20 microns to about 300 microns. The powder size distribution of the metal powder and/or the silicon nitride powder may be from about 20 microns to about 300 microns, about 40 microns to about 300 microns, about 60 microns to about 300 microns, about 80 microns to about 300 microns, about 100 microns to about 300 microns, about 120 microns to about 300 microns, about 140 microns to about 300 microns, about 160 microns to about 300 microns, about 180 microns to about 300 microns, about 200 microns to about 300 microns, about 220 microns to about 300 microns, about 240 microns to about 300 microns, about 260 microns to about 300 microns, about 280 microns to about 300 microns; about 20 microns to about 250 microns, about 40 microns to about 250 microns, about 60 microns to about 250 microns, about 80 microns to about 250 microns, about 100 microns to about 250 microns, about 120 microns to about 250 microns, about 140 microns to about 250 microns, about 160 microns to about 250 microns, about 180 microns to about 250 microns, about 200 microns to about 250 microns, about 220 microns to about 250 microns; about 20 microns to about 200 microns, about 40 microns to about 200 microns, about 60 microns to about 200 microns, about 80 microns to about 200 microns, about 100 microns to about 200 microns, about 120 microns to about 200 microns, about 140 microns to about 200 microns, about 160 microns to about 200 microns, about 180 microns to about 200 microns; about 20 microns to about 150 microns, about 40 microns to about 150 microns, about 60 microns to about 150 microns, about 80 microns to about 150 microns, about 100 microns to about 150 microns, about 120 microns to about 150 microns; about 20 microns to about 100 microns, about 40 microns to about 100 microns, about 60 microns to about 100 microns, about 80 microns to about 100 microns; about 20 microns to about 50 microns, or about 40 microns to about 50 microns. In an exemplary embodiment, the powder size distribution is about 20 microns to about 65 microns.

In some instances, the combined powder has a packing density of about 25 to about 60% of their theoretical values. For example, the packing density of the combined powdered may be about 25 to about 60%, about 30 to about 60%, about 35 to about 60%, about 40 to about 60%, about 45 to about 60%, about 50 to about 60%; about 25 to about 50%, about 30 to about 50%, about 35 to about 50%, about 40 to about 50%; about 25 to about 40%, about 30 to about 40%; or about 25 to about 35% of their theoretical values.

In step 120, the combined powder is received within a build chamber having a platform and a laser beam source operable to produce a laser beam. The combined powder may be received within the build chamber via manual or automatic mechanical means.

The build chamber may be configured to operate at atmospheric pressure during operation of the laser to fuse the combined powder. Additionally, or alternatively, the build chamber may contain nitrogen (N₂) gas, ammonia (NH₃) gas, hydrogen (H₂) gas and nitrogen (N₂), or a combination thereof during the operation in the laser. For example, in one embodiment, the build chamber contains (N₂) gas during operation. In another embodiment, the build chamber contains ammonia (NH₃) gas during operation. In yet a further embodiment, the build chamber contains a combination of hydrogen (H₂) gas and nitrogen (N₂) during operation.

In some embodiments, the laser beam may be a Nd:YAG laser beam. The laser beam may have a wavelength of 1064 nm, a focusing distance of about 250 mm, a laser spot size of between about 35 μm and about 200 μm, a nominal maximum power of about 17 kW, a burst energy of about 70 J, an applied potential of about 160-500 V, and/or a discharge time of about 1-20 ms. In some cases, the laser beam has a power level of about 300 W to about 700 W. For example, the laser beam may have a power level of about 350 W to about 700 W, about 400 W to about 700 W, about 450 W to about 700 W, about 500 W to about 700 W, about 550 W to about 700 W, about 600 W to about 700 W; about 300 W to about 600 W, about 350 W to about 600 W, about 400 W to about 600 W, about 450 W to about 600 W, about 500 W to about 600 W, about 550 W to about 600 W; about 300 W to about 500 W, about 350 W to about 500 W, about 400 W to about 500 W, about 450 W to about 500 W; about 300 W to about 400 W, or about 350 W to about 400 W. In some aspects, the laser spot size may be between about 35 μm and about 200 μm. For example, the laser spot size may be between about 35 μm to about 50 μm, about 35 μm to about 75 μm, about 35 μm to about 100 μm, about 35 μm to about 125 μm, about 35 μm to about 150 μm, about 35 μm to about 175 μm, about 175 μm to about 200 μm, about 150 μm to about 200 μm, about 125 μm to about 200 μm, about 100 μm to about 200 μm, about 75 μm to about 200 μm, or about 50 μm to about 200 μm. In some exemplary embodiments, the laser spot size is between about 35 μm to about 50 μm.

In step 130, a plurality of layers of the combined powder is spread over the platform. The combined layer may be spread or deposited over the platform and/or a target area thereof using any suitable known means. For example, a deposition mechanism may be used to deposit and/or spread the combined powder to form a layer of combined powder on the platform or a target area thereof. In some embodiments, the layer of combined powder may have a thickness of about 20 μm to about 300 μm. In some aspects, the layer of combined powder may have a thickness of about 20 μm to about 300 μm. For example, the layer of the combined powder may have a thickness of about 20 μm to about 50 μm, about 20 μm to about 75 μm, about 20 μm to about 100 μm, about 20 μm to about 125 μm, about 20 μm to about 150 μm, about 20 μm to about 175 μm, about 20 μm to about 200 μm, about 20 μm to about 225 μm, about 20 μm to about 250 μm, about 20 μm to about 275 μm, about 275 μm to about 300 μm, about 250 μm to about 300 μm, about 225 μm to about 300 μm, about 200 μm to about 300 μm, about 175 μm to about 300 μm, about 150 μm to about 300 μm, about 125 μm to about 300 μm, about 100 μm to about 300 μm, about 75 μm to about 300 μm, or about 50 μm to about 300 μm. In some exemplary embodiments, the combined powder layer has a thickness of about 20 μm to about 50 μm.

In step 140, at least a portion of the combined powder in each of the plurality of layers is fused using the laser beam. The selectively fused portions of the combined powder form a section of the component being manufactured. Thus, fusing a portion of the combined powder in the first layer, forms a first section of the component. Subsequently, another layer of the combined powder is spread over the platform or a target area thereof, and a portion of the combined powered in the second layer is fused using the laser beam to form a second section of the component. Fusing the portion of combined powder in the second layer typically also joins the first section of the component and second section of the component into a cohesive mass. Successive layers of the combined powder are spread over the platform or a target area thereof and then a portion of the combined powder of such successive layers is fused to form successive sections of the component. The fused portion of the combined powder (e.g., each section of the component) in each of the plurality of layers may be fused to at least one fused portion of combined powder (e.g., a section of component) in an adjacent layer of combined powder.

Method 100 may partially melt the combined powder using the laser beam. Typically, the combined powder is partially melted during selective laser sintering. For example, method 100 may include at least partially melting the metal powder to fuse the combined powder via selective laser sintering. Alternatively, the method 100 may fully melt the titanium alloy powder to fuse the combined powder during selective laser melting.

Method 100 may employ a laser beam to fuse, e.g., via melting or sintering, the combined powder by heating the combined powder to a temperature of about 1000° C. to about 1700° C. In some cases, the laser beam heats the combined powder to a temperature of about 1100° C. to about 1700° C., about 1200° C. to about 1700° C., about 1300° C. to about 1700° C., about 1400° C. to about 1700° C., about 1500° C. to about 1700° C., about 1600° C. to about 1700° C.; about 1000° C. to about 1600° C., about 1100° C. to about 1600° C., about 1200° C. to about 1600° C., about 1300° C. to about 1600° C., about 1400° C. to about 1600° C., about 1500° C. to about 1600° C.; about 1000° C. to about 1500° C., about 1100° C. to about 1500° C., about 1200° C. to about 1500° C., about 1300° C. to about 1500° C., about 1400° C. to about 1500° C.; about 1000° C. to about 1400° C., about 1100° C. to about 1400° C., about 1200° C. to about 1400° C., about 1300° C. to about 1400° C.; about 1000° C. to about 1300° C., about 1100° C. to about 1300° C., about 1200° C. to about 1300° C.; about 1000° C. to about 1200° C., about 1100° C. to about 1200° C.; or about 1000° C. to about 1100° C. to fuse the combined powder.

The laser beam may be controlled by a laser control mechanism operable to move the aim of the laser beam and/or modulate the laser beam to selectively fuse the portions of the combined powder in the layer of combined powder spread on the platform. The control mechanism may then operate the laser to selectively fuse portions of the combined powder in sequential layers of the plurality of layers, producing a completed component comprising a plurality of sections fused together.

In some embodiments, the control mechanism includes a computer (e.g. a CAD/CAM system) to determine the portions of combined powder in each of the plurality of layers to fuse. In one embodiment, the control mechanism and/or computer determines the boundaries for each of the portions of combined powder before fusing the combined power. For example, based on the dimensions and configuration of the component, the computer may determine an outline of the boundaries of the portion of combined powder to fuse.

Additionally, or alternatively, the method 100 may employ a mechanism for directing the laser beam and a mechanism for modulating the laser beam on and off to selectively fuse a portion of the combined powder. The laser beam may be directed in a continuous raster scan of the platform or a target area therein. In addition, the laser beam may be modulated, e.g., using a modulating mechanism to turn the laser beam on and off, so that the combined powder is fused only when the aim of the laser beam is toward the portions of combined powder to be fused. Alternatively, the laser beam may be directed toward only the portions of the combined powered to be fused so that the laser beam can be left on continuously to fuse the complete portion of combined powder for a particular layer of combined powder. In one embodiment, the laser beam is directed in a “vector” fashion. For example, the laser beam may be directed to first fuse an outline of the portion of the combined powder to be fused and then to fuse the combined powder within the outlined area. In yet another embodiment, the laser beam may be directed in a repetitive pattern and the laser beam modulated to fuse only a portion of the layer of combined powder.

The method 100 may employ a pair of mirrors to direct the laser beam. For instance, a first mirror may reflect the laser beam to a second mirror, which reflects the beam into the target area. Shifting movement of the first mirror shifts the laser beam generally in a first direction. Similarly, shifting movement of the second mirror shifts the laser beam in a second direction. The mirrors may be oriented relative to each other so that the first and second directions are generally perpendicular to each other. Such an arrangement allows for many different types of scanning patterns of the laser beam in the target area, including a raster scan pattern. Additional subject matter relating to the use of laser to sinter or melt a material may be found in U.S. Pat. No. 4,863,538; U.S. Pat. No. 4,944,817; U.S. Pat. No. 5,132,143; and U.S. Pat. No. 6,677,554, which are incorporated herein in their entirety for all purposes.

In step 150, after the component has been formed from the layer-by-layer fusion of step 140, the combined powder that was not fused by the laser beam is removed. The non-fused powder may be brushed and/or vacuumed away from and off of the fused component. For example, the combined powder that was not fused may be removed manually by brushing or automatically using a vacuum. In some embodiments, method 100 further includes removing the fused component from the chamber prior to removing any non-fused powder. For example, after the component is manufactured, the component may be allowed to cool down before excess or loose combined powder is removed from the manufactured component

In some cases, method 100 may further include machining a surface of the component. In an embodiment, machining the surface of the component includes polishing a surface of the component. The surface of the component may be machined and polished to a roughness of less than the order of the ten to twenty nanometers. In at least one embodiment, machining and polishing of the component includes performing chemical etching on a surface of the component.

According to a second aspect, provided is a component (e.g., an implant) comprising about 1 to about 35 vol. % of silicon nitride and about 65 to about 99 vol. % of a metal powder that is produced by a method including blending a silicon nitride powder and a metal powder to form a combined powder; receiving the combined powder within a build chamber having a platform and a laser beam source operable to produce a laser beam; spreading a plurality of layers of the combined powder over the platform; fusing at least a portion of the combined powder in each of the plurality of layers using the laser beam, wherein each one of the plurality of layers is spread and the portion of the combined powder fused before another one of the plurality of layers is spread, wherein the laser beam is automatically guided by a 3D model of the component; and removing the combined powder that was not fused. In some instances, the implant may be manufactured using one or more features of method 100, which is discussed above.

The component typically includes about 1 to about 35 vol. % of silicon nitride and about 65 to about 99 vol. % of a titanium alloy powder, based on the total weight of the implant. In some cases, the amount of silicon nitride present in the component ranges from about 1 to about 35 vol. %, about 2 to about 35 vol. %, about 5 to about 35 vol. %, about 10 to about 35 vol. %, about 15 to about 35 vol. %, about 20 to about 35 vol. %, about 25 to about 35 vol. %; about 1 to about 30 vol. %, about 2 to about 30 vol. %, about 5 to about 30 vol. %, about 10 to about 30 vol. %, about 15 to about 30 vol. %, about 20 to about 30 vol. %, about 25 to about 30 vol. %; about 1 to about 25 vol. %, about 2 to about 25 vol. %, about 5 to about 25 vol. %, about 10 to about 25 vol. %, about 15 to about 25 vol. %, about 20 to about 25 vol. %; about 1 to about 20 vol. %, about 2 to about 20 vol. %, about 5 to about 20 vol. %, about 10 to about 20 vol. %, about 15 to about 20 vol. %; about 1 to about 15 vol. %, about 2 to about 15 vol. %, about 5 to about 15 vol. %, about 10 to about 15 vol. %; about 1 to about 10 vol. %, about 2 to about 10 vol. %, about 5 to about 10 vol. %; or about 1 to about 5 vol. %, based on the total weight of the implant.

The component typically comprises about 65 to about 99 vol. % of a metal powder, based on the total weight of the component. For example, the component may include about 65 to about 99 vol. %, about 70 to about 99 vol. %, about 75 to about 99 vol. %, about 80 to about 99 vol. %, about 85 to about 99 vol. %, about 90 to about 99 vol. %, about 95 to about 99 vol. %; about 67 to about 95 vol. %, about 70 to about 95 vol. %, about 75 to about 95 vol. %, about 80 to about 95 vol. %, about 85 to about 95 vol. %, about 90 to about 95 vol. %; about 67 to about 90 vol. %, about 70 to about 90 vol. %, about 75 to about 90 vol. %, about 80 to about 90 vol. %, about 85 to about 90 vol. %; about 67 to about 85 vol. %, about 70 to about 85 vol. %, about 75 to about 85 vol. %, about 80 to about 85 vol. %; about 67 to about 80 vol. %, about 70 to about 80 vol. %, about 75 to about 80 vol. %; about 67 to about 75 vol. %, or about 70 to about 75 vol. % of metal powder, based on the total weight of the component.

In some examples, the metal may include, but is not limited to titanium alloys, steel, nickel based superalloys, austenitic nickel-chromium-based superalloys, copper, aluminum, stainless steel, tool steels, cobalt-chromium alloys, tungsten alloys, silicon, and silicon alloys. In an embodiment, the metal is titanium alloy. In one embodiment, the titanium alloy powder is Ti6Al4V.

The component may further include about 0.1 vol. % or more of iron, aluminum, copper, nickel, cobalt, chromium, alloys thereof, or combinations thereof based on the total weight of the component. The amounts of the foregoing components may be included in the components to enhance certain properties of the component, such as strength, impact resistant, ductility, bioactivity, corrosion resistance and/or compatibility. In some instances, the component may have about 0.1 vol. % to about 30 vol. % of iron, aluminum, copper, nickel, cobalt, chromium, alloys thereof, or combinations thereof, based on the total weight of the component. For example, the component may have about 0.1 to about 30 vol. %, about 0.1 to about 25 vol. %, about 0.1 to about 20 vol. %, about 0.1 to about 15 vol. %, about 0.1 to about 10 vol. %, about 0.1 to about 5 vol. %; about 1 to about 30 vol. %, about 1 to about 25 vol. %, about 1 to about 20 vol. %, about 1 to about 15 vol. %, about 1 to about 10 vol. %, about 1 to about 5 vol. %; about 5 to about 30 vol. %, about 5 to about 25 vol. %, about 5 to about 20 vol. %, about 5 to about 15 vol. %, about 5 to about 10 vol. %; about 10 to about 30 vol. %, about 10 to about 25 vol. %, about 10 to about 20 vol. %, about 10 to about 15 vol. %; about 15 to about 30 vol. %, about 15 to about 25 vol. %, about 15 to about 20 vol. %; about 20 to about 30 vol. %, about 20 to about 25 vol. %, or about 25 to about 30 vol. %, based on the total weight of the component, of iron, aluminum, copper, nickel, cobalt, chromium, alloys thereof, or combinations thereof.

Preferably, the component (e.g., an implant) is antipathogenic. For example, the component may inhibit the proliferation of at least one of bacteria, fungi, and viruses. Additionally, and/or alternatively, the component may be configured to be an implant that enhances osteoblast cell proliferation. In at least one embodiment, the osteoblast cell proliferation increases on the implant as compared to an implant without the silicon nitride powder. The component may have a surface chemistry that accelerates bone repair. In some embodiments, the component (e.g., an implant) releases silicic acid and reactive nitrogen species (RNS) from the surface of the component, which enhances the osteogenic activity of osteosarcoma and mesenchymal cells both at the initial stages of cell differentiation and during subsequent bony apatite deposition. Without being limited to any particular theory, the silicon nitride powder may stimulate the synthesis by osteoblasts of high-quality bone tissue, the former favoring bone matrix mineralization and the latter enhancing cell proliferation and formation of bone matrix. In addition, the component may possess a surface chemistry that is biocompatible and provides a number of biomedical applications including concurrent osteogenesis, osteoinduction, osteoconduction, and bacteriostasis.

The component may be in the form of an implant, which may be implanted in a patient's body in an area contacting or near bone. Non-limiting examples of implants include an intervertebral spinal spacers or cages, bone screws, orthopedic plates, and other fixation devices, articulation devices in the spine, hip, knee, shoulder, ankle, and phalanges, implants for facial or other reconstructive plastic surgery, middle ear implants, dental devices, and the like.

### EXAMPLE

Implementation of the present disclosure is provided by way of the following example. The example serves to illustrate the technology without being limiting in nature.

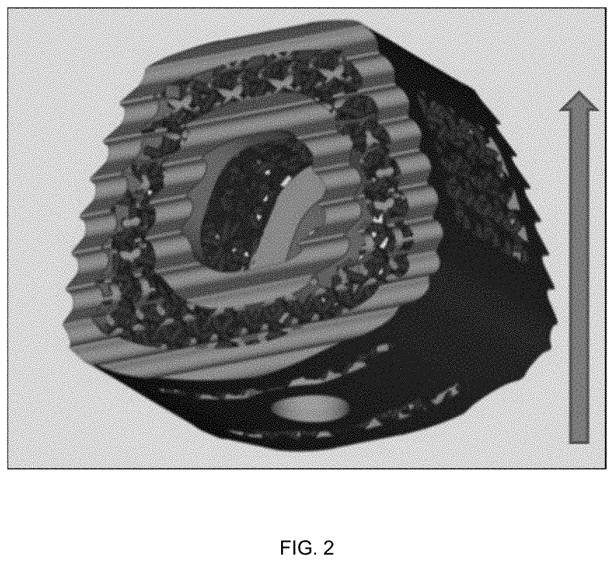

A cervical spinal implant was manufactured in accordance with aspects of the disclosure herein. A CAD model and drawing was produced based on the design of the implant and a build orientation was selected as shown in FIG. 2. The implant had dimensions of 16 mm×14 mm×9 mm.

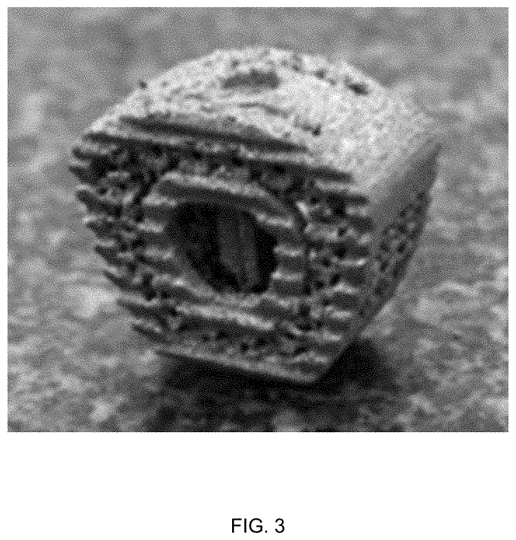

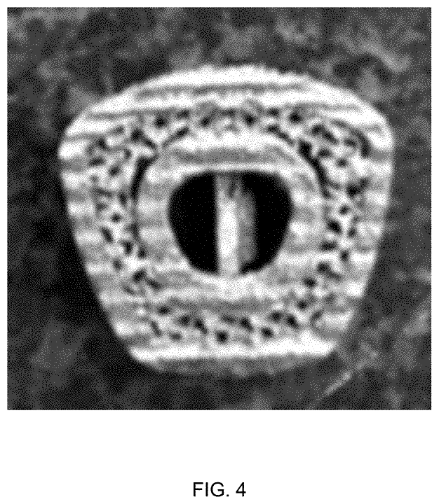

Based on the design and dimensions of the implant, a DMG Mori LASERTEC LT 30 SLM machine (a selective laser melting device) was set up to manufacture the implant. The laser beam had a standard power level of 600 W. Each layer of the powder to be fused had a thickness of 50 μm. The powder contained 15 vol. % silicon nitride powder and 85 vol. % Ti6Al4V. The manufactured implant had a weight of about 3 grams. An image of the implant is shown in FIGS. 3 and 4.

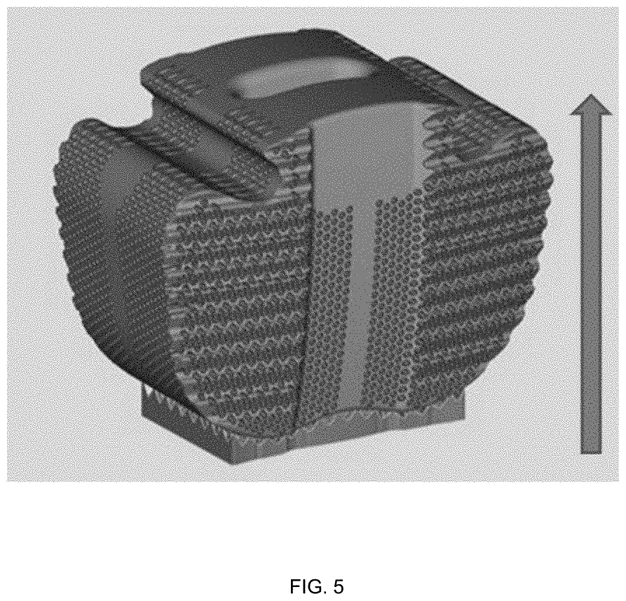

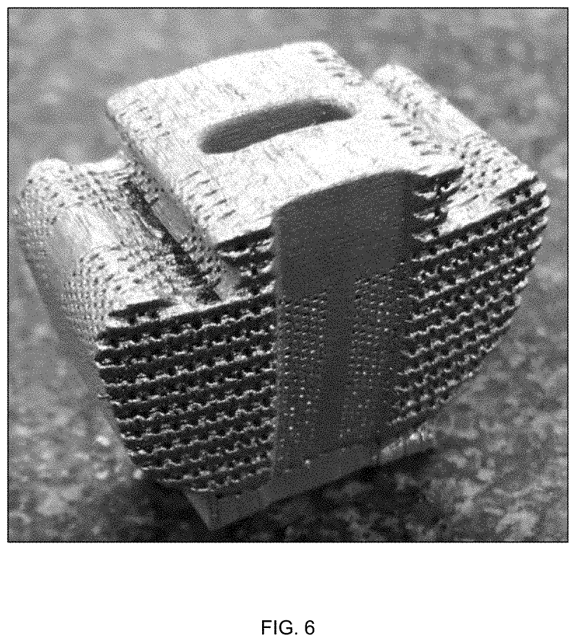

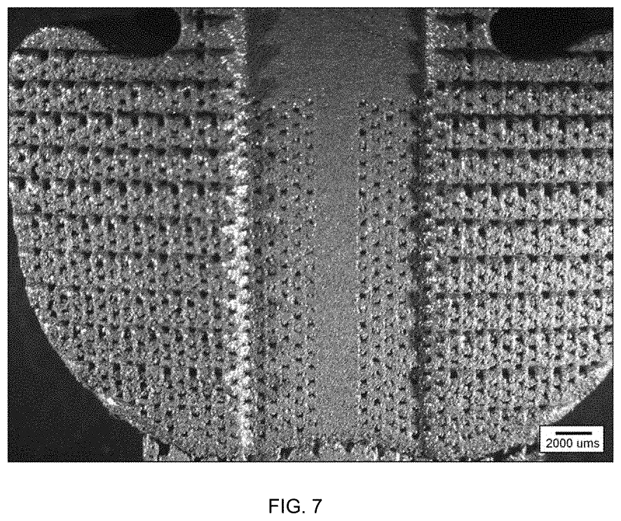

A Lumber spinal implant was also manufactured in accordance with the aspects of the disclosure herein. A CAD model and drawing of this device was produced based on the design of the implant and a build orientation was selected as shown in FIG. 5. The implant had dimensions 36 mm×28 mm×22 mm. Based on the design and dimensions of the implant, a DMG Mori LASERTEC LT 30 SLM machine was set up to manufacture the implant. The laser beam had a standard powder level of 600 W, and each layer of the powder to be fused had a thickness of 50 μm. The powder contained 15 vol % silicon nitride and 85 vol. % Ti6Al4V. The manufactured implant had a weight of about 33 grams. An image of the implant is shown in FIG. 6 and FIG. 7. FIG. 7 shows a close-up view of detail of the implant.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for manufacturing a component, the method comprising:
blending a silicon nitride powder and a metal powder to form a combined powder;
receiving the combined powder within a build chamber having a platform and a laser beam source configured to produce a laser beam;
spreading a plurality of layers of the combined powder over the platform;
fusing at least a portion of the combined powder in each of the plurality of layers using the laser beam, wherein each one of the plurality of layers is spread and the portion of the combined powder fused before another one of the plurality of layers is spread, and wherein the laser beam is automatically guided by a 3D model of the component; and
removing from the fused component from the combined powder that was not fused.

2. The method of claim 1, wherein the metal powder is selected from powders comprising titanium alloy, steel, nickel based superalloys, austenitic nickel-chromium-based superalloys, copper, aluminum, stainless steel, tool steels, cobalt-chromium alloys, tungsten alloys, silicon, and silicon alloys.

3. The method of claim 1, wherein the metal powder is a titanium alloy powder.

4. The method of claim 3, wherein the titanium alloy powder is Ti-6Al-4V.

5. The method of claim 1, wherein the combined powder contains about 5 to about 25 vol. % of silicon nitride powder and about 75 to about 95 vol. % of metal powder.

6. The method of claim 5, wherein the combined powder contains about 10 to about 20 vol. % of silicon nitride powder and about 80 to about 90 vol. % of metal powder.

7. The method of claim 6, wherein the combined powder is about 15 vol. % of silicon nitride powder and about 85 vol. % of metal powder.

8. The method of claim 1, wherein the combined powder consists of silicon nitride powder and titanium alloy powder.

9. The method of claim 1, wherein the silicon nitride powder has a powder size distribution of about 20 microns to about 300 microns.

10. The method of claim 1, wherein the metal powder has a powder size distribution of about 20 microns to about 300 microns.

11. The method of claim 1, wherein the combined powder has a packing density of about 25 to about 60% of their theoretical values.

12. The method of claim 1, wherein the laser fuses via melting the combined powder by heating the combined powder to a temperature of about 1000° C. to about 1700° C.

13. The method of claim 1, wherein the pressure within the build chamber is at atmospheric pressure.

14. The method of claim 1, wherein the build chamber contains nitrogen (N₂) gas.

15. The method of claim 1, wherein the build chamber contains ammonia (NH₃) gas.

16. The method of claim 1, wherein the build chamber contains a combination of hydrogen (H₂) gas and nitrogen (N₂).

17. The method of claim 1, further comprising:
machining a surface of the component.

18. The method of claim 17, wherein machining the surface comprises polishing a surface of the component and/or performing chemical etching on a surface of the component.

19. An implant comprising about 1 to about 35 vol. % of silicon nitride and about 35 to about 99 vol. % of a titanium alloy powder, wherein the implant is produced by a method comprising:
blending a silicon nitride powder and a titanium alloy powder to form a combined powder;
receiving the combined powder within a build chamber having a platform and a laser beam source configured to produce a laser beam;
spreading a plurality of layers of the combined powder over the platform;
fusing at least a portion of the combined powder in each of the plurality of layers using the laser beam, wherein each one of the plurality of layers is spread and the portion of the combined powder fused before another one of the plurality of layers is spread, and wherein the laser beam is automatically guided by a 3D model of the component; and
removing from the fused implant the combined powder that was not fused by the laser.

20. The implant of claim 19, wherein the metal powder is selected from powders comprising titanium alloy, steel, nickel based superalloys, austenitic nickel-chromium-based superalloys, copper, aluminum, stainless steel, tool steels, cobalt-chromium alloys, tungsten alloys, silicon, and silicon alloys

21. The implant of claim 19, wherein the metal powder is Ti-6Al-4V.

22. The implant of claim 19, wherein the implant further comprises about 0.1 vol. % or more of iron, aluminum, copper, nickel, cobalt, chromium, alloys thereof, or combinations thereof.
